(19) United States
(12) Patent Application Publication
(10) Pub. No.: US 2018/0234822 A1
(43) Pub. Date: Aug. 16, 2018

(54) METHOD AND CONTROL NODE FOR HANDLING INCOMING COMMUNICATION IN A VEHICLE

(71) Applicant: Telefonaktiebolaget LM Ericsson (publ), Stockholm (SE)

(72) Inventors: Hongxin LIANG, UPPLANDS VÄSBY (SE); Karthikeyan PREMKUMAR, CHENNAI (IN); Keven WANG, KISTA (SE); Konstantinos VANDIKAS, SOLNA (SE)

(21) Appl. No.: 15/518,008

(22) PCT Filed: Nov. 11, 2014
(86) PCT No.: PCT/SE2014/051335

§ 371 Date: Apr. 10, 2017

(51) Int. Cl. H04W 4/40; H04L 12/58; H04M 3/54

(52) U.S. Cl. CPC H04W 4/40; H04W 4/023; H04M 3/54; H04L 51/14

(57) ABSTRACT

A method and a control node for handling incoming communication directed to a first wireless device when a user of the first wireless device is driving a vehicle. The control node detects a second wireless device that is present in the vehicle. When an incoming communication directed to the first wireless device is received, the control node forwards the incoming communication to the second wireless device, to enable a user of the second wireless device to act upon the incoming communication. Thereby, the first wireless device will not emit any sound or vibration and its user will not be distracted and tempted to look at the device and/or respond to the communication. The control node may be implemented in the first wireless device, a network node or a vehicle node.

### TECHNICAL FIELD

The present disclosure relates generally to a method and a control node for handling incoming communication arriving in a vehicle, to reduce distraction of a driver of the vehicle.

### BACKGROUND

It is a well-known fact that when a user of a wireless device is driving a vehicle, such as a car, the user can easily be distracted from driving when the device emits a sound or vibration indicating that an incoming call, message or notification has arrived. The user commonly wants to act upon the incoming communication in some way, e.g. by checking who is sending the communication, answering the call, looking at the message or notification on the device, or simply by pressing a key or similar on the device to indicate busy. The user may even be tempted to send a message in reply to the incoming communication which typically requires extensive manipulation of small keys or similar on the device.

The above behavior is a distraction that can of course be a safety risk since it diverts the user's concentration from driving the vehicle which may fatefully result in an accident, even for a short moment of distraction. In some countries it is even strictly forbidden for car and lorry drivers to operate a wireless device for calling and handling messages etc., at the same time as driving due to the risks associated therewith. The use of “hands-free” devices may reduce such risks to some extent but the driver may still be distracted by focusing on the communication instead of the driving, so the risk for accident due to distraction cannot be eliminated by the hands-free usage.

In this disclosure the term “wireless device” may represent any kind of user operated communication device capable of radio communication with a wireless network. Some illustrative but non-limiting examples of wireless device include mobile phone, smartphone, tablet, and laptop computer. As indicated above, it is a problem that an incoming communication directed to a wireless device present in a vehicle, may cause hazardous distraction to a user of the wireless device when driving the vehicle.

### SUMMARY

It is an object of embodiments described herein to address the problems and issues outlined above. It is possible to achieve this object and others by using a method and a control node as defined in the attached independent claims.

According to one aspect, a method is performed by a control node for handling incoming communication directed to a first wireless device when a user of the first wireless device is driving a vehicle. In this method, the control node detects a second wireless device that is present in the vehicle. When receiving an incoming communication directed to the first wireless device, the control node forwards the incoming communication to the second wireless device, thereby enabling a user of the second wireless device to act upon the incoming communication.

According to another aspect, a control node is arranged to handle incoming communication directed to a first wireless device when a user of the first wireless device is driving a vehicle. The control node comprises means, e.g. a detecting module, configured to detect a second wireless device that is present in the vehicle, and means, e.g. a receiving module, configured to receive an incoming communication directed to the first wireless device. The control node also comprises means, e.g. a forwarding module, configured to forward the incoming communication to the second wireless device, thereby enabling a user of the second wireless device to act upon the incoming communication.

When using the above method and control node, the user of the first wireless device will not be distracted and tempted to look at the device and/or respond to the communication. He/she can thus concentrate on driving the vehicle with a minimum of distraction while the user of the second wireless device can take care of the communication on behalf of the user of the first wireless device.

The above method and control node may be configured and implemented according to different optional embodiments to accomplish further features and benefits, to be described below.

A computer program is also provided comprising instructions which, when executed on at least one processor, cause the at least one processor to carry out the above method. A carrier is also provided which contains the above computer program, wherein the carrier is one of an electronic signal, optical signal, radio signal, or a non-tangible computer readable storage medium.

### BRIEF DESCRIPTION OF DRAWINGS

The solution will now be described in more detail by means of exemplary embodiments and with reference to the accompanying drawings, in which:

FIG. 1 is a communication scenario illustrating how an incoming communication directed to a wireless device in a vehicle can be handled, according to some possible embodiments.

FIG. 2 is a flow chart illustrating a procedure in a control node, according to further possible embodiments.

FIG. 3 is a flow chart illustrating an example of a more detailed procedure in a control node, according to further possible embodiments.

FIG. 4 is a signaling diagram illustrating an example of a procedure when the control node is implemented in a wireless device, according to further possible embodiments.

FIG. 5 is another signaling diagram illustrating an example of a procedure when the control node is implemented in a network node, according to further possible embodiments.

FIG. 6 is another signaling diagram illustrating an example of a procedure when the control node is implemented in a vehicle node, according to further possible embodiments.

FIG. 7 is a block diagram illustrating a control node in more detail, according to further possible embodiments.

FIG. 8 is another signaling diagram illustrating a first example of a pairing procedure with two wireless devices, according to further possible embodiments.

FIG. 9 is another signaling diagram illustrating a second example of a pairing procedure with two wireless devices, according to further possible embodiments.

### DETAILED DESCRIPTION

Briefly described, a solution is provided to avoid or at least reduce distraction to a user of a first wireless device by an incoming communication while the user is driving a vehicle. This is accomplished by forwarding the incoming communication to a second wireless device that is also present in the vehicle to enable a user of the second wireless device to act upon the incoming communication instead of the first user. Thereby, the first wireless device will not need to emit any sound or vibration and its user will not be distracted and tempted to look at the device and/or respond to the communication. The driver can thus concentrate on driving the vehicle with a minimum of distraction while the second user can take care of the communication on behalf of the first user.

In this disclosure, the term “incoming communication” should be interpreted rather broadly to represent an event at the device that generates an alert such as a sound or vibration and which can be acted upon, such as an incoming call, message or notification. Without limitation, the call may be a regular telephone call and the message may be a Short Message Service, SMS, message. The notification may be an external notification which indicates that an email or information feed has been received. The notification may also be an internal notification such as a reminder generated locally in the first device by means of an alarm clock function or the like. The incoming communication may further be some pushed content such as an advertisement, announcement, or similar. The solution is however not strictly limited to the examples described above.

The solution and its embodiments described herein can be implemented in a functional entity which will be referred to as a “control node”, although other terms are also possible to use, e.g. “call manager”, “forwarding manager”, “call forwarding node”, to mention a few possible alternatives. The above forwarding functionality can thus be achieved by means of a method and a control node, and various possible features and embodiments will be described herein in the context of some illustrative examples. The control node thus represents a functional entity where the features and embodiments described herein can basically be executed.

The control node may be implemented in the first wireless device itself, or in a network node of a public wireless network, e.g. a Third Generation Partnership Project, 3GPP, network, which is serving the first and second wireless devices. A third alternative is to implement the control node in a vehicle node which resides in the vehicle and is capable of wireless communication with the first and second wireless devices. In the latter case, the vehicle node and the first and second devices may form a local network, e.g. using WiFi communication.

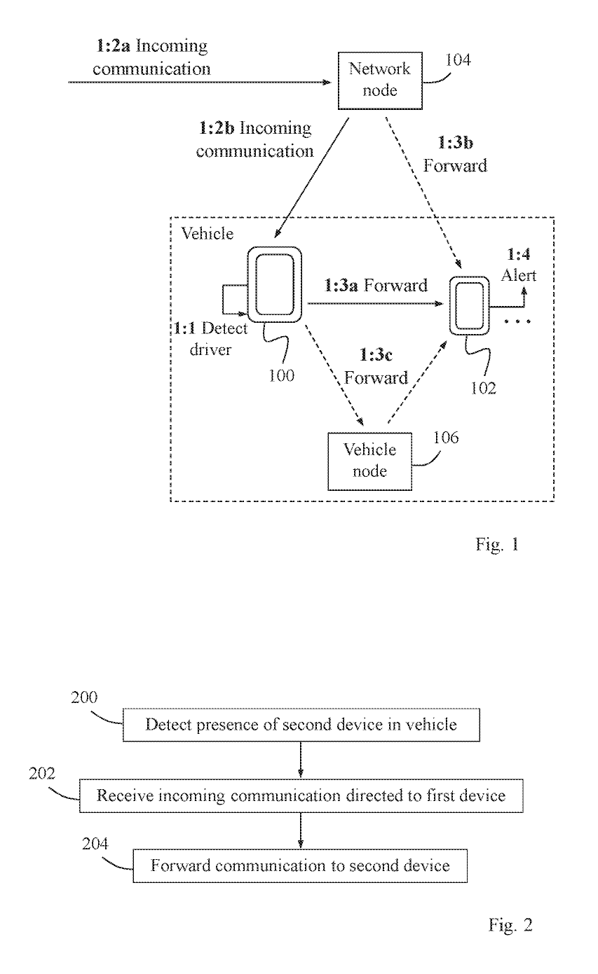

An example of a procedure for putting the solution into practice will now be described with reference to the communication scenario illustrated in FIG. 1. Various options are also schematically shown in this figure, depending on where the above-mentioned control node is implemented. This example involves a first wireless device 100 and at least a second wireless device 102, both being present in a vehicle, e.g. a car. It is assumed that a user of the first wireless device 100 is driving the vehicle, while a user of the second wireless device 102 is a passenger in the vehicle. The control node may be implemented according to three possible options: in the first wireless device 100, in a network node 104 of a public wireless network, or in a vehicle node 106 residing in the vehicle and being in communication with the first and second wireless devices 100, 102. All these nodes and devices are illustrated schematically in FIG. 1.

A first action 1:1 illustrates that it is somehow detected that the user of the first device 100 is the driver of the vehicle. This may be detected in various different ways. One option is that the first device's user, called the first user, actively enters a code or pushes a button or similar to or on the device 100, to indicate that this user is now the driver. Alternatively, a sensor, not shown, in the vehicle may automatically detect the driver and identify him/her as owner of the first device 100, e.g. by detecting characteristic movements, a certain weight or other personal characteristics at the driver's seat, to mention a few examples. Another example is that a “wearable sensor” such as smart watch or digital bracelet can be arranged to detect that the first user is the driver and hence inform the first device 100. The solution is not limited to any particular way of detecting the driver.

In either case, a driver notification may be generated which may be issued from the first wireless device 100 or from the above sensor, depending on the detection, which will be described further below. The driver notification thus effectively indicates that any incoming communication directed to the first device 100 should be forwarded to another device being present in the vehicle, if possible, in order to avoid or reduce distraction to the driver.

Another action 1:2a illustrates that the network node 104 receives an incoming communication in this example, which is directed or destined to the first wireless device 100. The network node 104 may send the communication to the first wireless device 100, as shown by another action 1:2b. On the other hand, if the control node is implemented in the network node 104, it may forward the communication to another device in the vehicle instead of sending it to the first wireless device 100, if it is determined that the communication should be forwarded to such a device as follows.

This procedure includes detecting that the second wireless device 102 is present in the vehicle, which is not illustrated as an action here since it can be made in several different ways depending on where and how the control node is implemented. One option is that the first device 100 detects proximity to the second device 102, e.g. by sensing radio signals transmitted therefrom, or by establishing a short-range communication link with the device 102, e.g. using Bluetooth or similar. Another option is that the vehicle node 106 has connected with the first and second wireless devices 100, 102 using short-range communication, e.g. Bluetooth, WiFi or similar. A third option is that the network node 104 detects the presence of the second device 102 in the vehicle based on positioning information available in the wireless network which may indicate that the devices 100, 102 are co-located and moving in the same direction. Furthermore, having detected the presence of device 102 in the vehicle in either way, the device 100 or any of the nodes 104 and 106 may send a “proximity notification” or the like to wherever the control node is implemented, to indicate that the second wireless device 102 is present in the vehicle.

From the above-described actions and options, it can be gathered that the control node is now informed that the user of the first wireless device 100 is driving the vehicle and that the second wireless device 102 is also present in the vehicle. In FIG. 1, three alternative actions 1:3a-c, to be described below, illustrate that the incoming communication is forwarded to the second device 102 so that the second user can take care of the communication, e.g. by answering a call, reading a message, sending a response, checking who the communication comes from, and so forth. It may also be first checked if the second wireless device 102 is suitable and allowed to take the incoming communication, e.g. based on predefined forwarding rules, which will be described in more detail in further examples later below.

In one option illustrated by action 1:3a, it is the first wireless device 100 that forwards the incoming communication to the second device 102, either over a short-range communication link such as Bluetooth or WiFi, or over the serving public wireless network which may involve the network node 104 acting as a base station to which both devices 100 and 102 are connected.

In another option illustrated by action 1:3b, it is the network node 104 that forwards the incoming communication to the second device 102 over the serving public wireless network, as indicated by a first dashed arrow. In this case, the network node 104 may refrain from sending the communication to the first device 100, thus omitting the above action 1:2b. However, if the incoming communication is a message such as an SMS message, it may be sent to the first device 100 as well, even if it is also forwarded to second device 102 which will emit an alerting sound or vibration to enable its user to act upon the communication, although the first device 100 preferably does not emit any alerting sound or vibration. Even if both devices 100 and 102 emit a sound or vibration, the first user can be confident that the second user can take care of the communication.

In yet another option illustrated by action 1:3c, it is the vehicle node 106 that forwards the incoming communication to the second device 102, e.g. by first receiving the communication from the first device 100 and then sending it to the second device 102, as indicated by second and third dashed arrows. These three different options 1:3a-c will be described in more detail in separate examples later below. In either case, having received the forwarded communication, the second wireless device 102 emits an alerting sound or vibration in a final shown action 1:4, to enable the second user to act upon the incoming communication, thus not diverting the driver's attention from the driving.

An example of how the solution may be employed will now be described with reference to the flow chart in FIG. 2 which illustrates a procedure with actions performed by a control node to accomplish the functionality described above. The control node is operative to handle any incoming communication directed to a first wireless device when a user of the first wireless device is driving a vehicle.

A first action 200 illustrates that the control node detects a second wireless device that is present in the vehicle. The first and second wireless devices in this procedure may be the devices 100 and 102 of the previous example. In a possible embodiment, the user of the first wireless device may have been detected as driving the vehicle based on a driver notification from the first wireless device or from a sensor in the vehicle, which has been described above.

In a next action 202, the control node receives an incoming communication directed to the first wireless device. In further possible embodiments, the incoming communication may comprise any of: a phone call, pushed content, a message and an external or internal notification. Some practical examples of what the incoming communication could be have been outlined above.

A final shown action 204 illustrates that the control node forwards the incoming communication to the second wireless device, thereby enabling a user of the second wireless device to act upon the incoming communication.

It is an advantage of this solution that the user of the first device will not be distracted by the incoming communication and tempted to act upon it which could otherwise be a substantial security risk since the user may not be able to fully concentrate on the driving. Another advantage is that the forwarding of the communication is performed automatically without requiring manual action, provided that another wireless device is detected as present in the vehicle, which device possibly also satisfies a set of predefined forwarding rules to be exemplified and described in more detail below. Several optional embodiments of this procedure are possible and some examples will now be described.

In further possible embodiments, the incoming communication may be forwarded to the second wireless device based on predefined forwarding rules pertaining to the first wireless device. These forwarding rules effectively dictate whether the second wireless device is suitable and allowed to take the incoming communication depending on whether the second device can satisfy those rules or not. The forwarding rules may be defined so as to ensure that privacy and integrity of the first user are not jeopardised by forwarding the incoming communication to an unsuitable person's device.

The forwarding rules may be related to at least one of the following factors A-H, although the solution is not generally limited to these examples.

A) The forwarding may be allowed if the second wireless device has previously been assigned to receive the incoming communication. This option may be implemented by means of an agreement or the like, valid for the first and second devices. This agreement may be defined by executing a pairing procedure for the first and second devices and some examples of pairing procedure will be illustrated and described in more detail later below. A pairing agreement may be manifested and maintained in a pairing record which can be accessed by the control node. A forwarding priority may further be set for different wireless devices which are assigned to receive various incoming communications, such that an incoming communication will be forwarded to the device having the highest priority in the vehicle if there are multiple devices present in the vehicle with different forwarding priorities.

B) The forwarding may be allowed if at least one previous incoming communication has been forwarded to the second wireless device. This condition effectively implies that the second wireless device has been allowed to take a communication directed to the first wireless device at least once before, and it can therefore be assumed that it can be allowed again to take the present communication.

C) The forwarding may be allowed if the first and second wireless devices have communicated with one another at least a certain number of times. This condition effectively implies that the second wireless device and its user are known to the user of the first wireless device, and it can therefore be assumed that the second device can be allowed to take the present incoming communication. It may be required that the first and second wireless devices have communicated, say, five times or more, to assure that their users are sufficiently acquainted.

D) The forwarding may be allowed if a contact list in the second wireless device includes the first wireless device. This condition effectively implies that the second wireless device and its user are known to the user of the first wireless device, and it can therefore be assumed that the second device can be allowed to take the present incoming communication.

E) The forwarding may be allowed if a contact list in the first wireless device includes the second wireless device. This condition is similar to the previous condition and it can therefore be assumed that the second device can be allowed to take the present incoming communication for the same reason.

F) The forwarding may be allowed depending on the type of communication received. For example, the forwarding rules may allow that calls and notifications are allowed to be forwarded but not messages which may be deemed more private.

G) The forwarding may be allowed depending on the origin of the incoming communication. This condition may dictate that if the incoming communication origins from one of a set of approved sources, e.g. callers or senders in a “white list” or a particular contact group or the like, e.g. exclusively comprising family members, the communication is allowed to be forwarded. If not so, the communication must not be forwarded. Conversely, this condition may dictate that if the incoming communication origins from one of a set of non-approved sources, e.g. callers or senders in a “black list” or the like, the communication is not allowed to be forwarded. If not so, the communication is allowed to be forwarded.

H) The forwarding may be allowed depending on the time of day, week or season. This condition may dictate that the incoming communication is allowed to be forwarded only at certain times of day, week or season. For example, the communication may be allowed to be forwarded only on weekends, or after 7 pm, or between July 1 and August 15, and so forth.

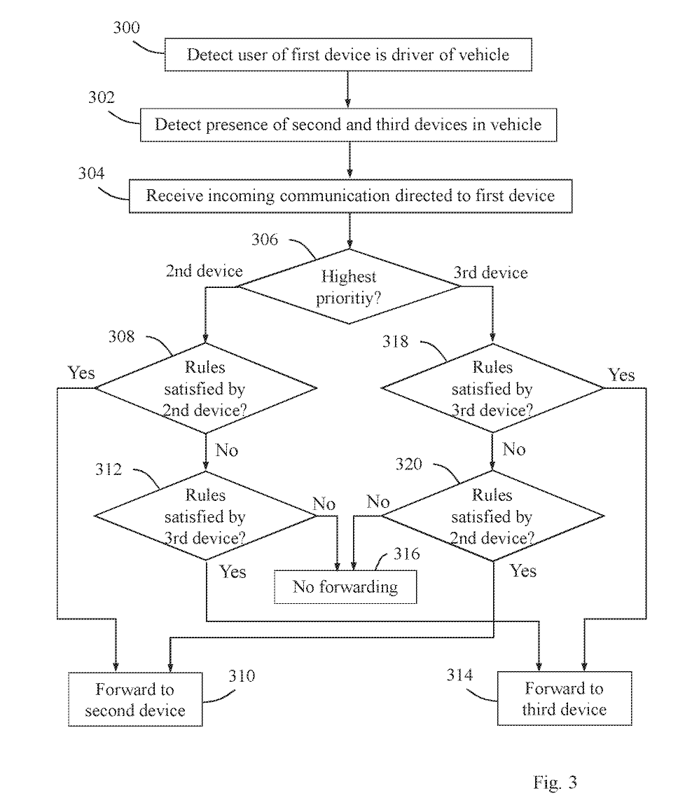

It was mentioned above that if there are more than one potential candidate device present in the vehicle for taking an incoming communication directed to the first device, the forwarding of the communication may be dependent on predefined forwarding priorities of the devices. In another possible embodiment, if at least a third wireless device is also present in the vehicle in the procedure of FIG. 2, the second wireless device is selected to receive the incoming communication based on a forwarding priority of the second wireless device being higher than a forwarding priority of the third wireless device. This mechanism will now be described in more detail with reference to an example illustrated by the flow chart in FIG. 3.

In this example, it is assumed that a user of a first wireless device is driving the vehicle and forwarding priorities have been assigned to a second wireless device and a third wireless device, respectively. It is also assumed that forwarding rules have been defined for the first wireless device, e.g. relating to one or more of the above-described factors A-H.

A first action 300 illustrates that the control node detects that the user of the first wireless device is driving the vehicle, and another action 302 illustrates that the control node detects that both the second wireless device and the third wireless device are present in the vehicle. Some examples of how these detection actions may be executed as such have been described above which will not be repeated here. In a further action 304, an incoming communication directed to the first device is received, e.g. as described for action 202 above.

The control node then retrieves the forwarding priorities of the second and third wireless devices and determines in an action 306 which one of the two devices has the highest forwarding priority. If the forwarding priority of the second wireless device is higher than the forwarding priority of the third wireless device, the control node then retrieves the forwarding rules of the first device and proceeds to action 308 by determining if the forwarding rules are satisfied by the second wireless device or not. If so, the incoming communication is forwarded to the second wireless device in an action 310.

On the other hand, if the control node finds in action 308 that the forwarding rules are not satisfied by the second wireless device, the control node proceeds to action 312 by determining if the forwarding rules are satisfied by the third wireless device or not. If so, the incoming communication is forwarded to the third wireless device in an action 314. On the other hand, if the control node finds in action 312 that the forwarding rules are not satisfied by the third wireless device either, the control node refrains from forwarding the communication at all, in an action 316, since none of the second and third wireless devices satisfies the forwarding rules according to actions 308 and 312. It can therefore be concluded that none of their users appears to be qualified to take care of the incoming communication.

Returning to action 306, if the control node instead finds that the forwarding priority of the third wireless device is higher than the forwarding priority of the second wireless device, the control node proceeds to action 318 by determining if the forwarding rules are satisfied by the third wireless device or not. If so, the incoming communication is forwarded to the third wireless device as of action 314.

On the other hand, if the control node finds in action 318 that the forwarding rules are not satisfied by the third wireless device, the control node proceeds to action 320 by determining if the forwarding rules are satisfied by the second wireless device or not. If so, the incoming communication can be forwarded to the second wireless device as of action 310. On the other hand, if the control node finds in action 312 that the forwarding rules are not satisfied by the second wireless device either, the control node refrains from forwarding the communication, as of action 316, since none of the second and third wireless devices satisfies the forwarding rules according to actions 318 and 320.

The above-described procedure in FIG. 3 thus basically illustrates an algorithm that the control node can execute automatically for determining how to handle the incoming communication, that is depending on the forwarding priorities of the second and third wireless devices and further depending on the forwarding rules defined for the first device.

It was mentioned above that the control node may be implemented in different nodes according to three options. In one possible embodiment, the control node may be implemented in the first wireless device, e.g. such as device 100 in FIG. 1. In that case, another possible embodiment may be that the first wireless device forwards the incoming communication to the second wireless device over a short-range radio link such as a Bluetooth link or a WiFi link, or over a public wireless network.

A more detailed example of how the control node and its functionality may be implemented in the first wireless device will be described later below with reference to the signalling diagram of FIG. 4.

In a further possible embodiment, the control node may instead be implemented in a network node of a wireless network, e.g. such as the network node 104 in FIG. 1. In that case, further possible embodiments may include that the network node forwards the incoming communication to the second wireless device after retrieving at least one of:
pairing information about the first and second wireless devices,
relative proximity of the first and second wireless devices, and
predefined forwarding rules pertaining to the first wireless device.

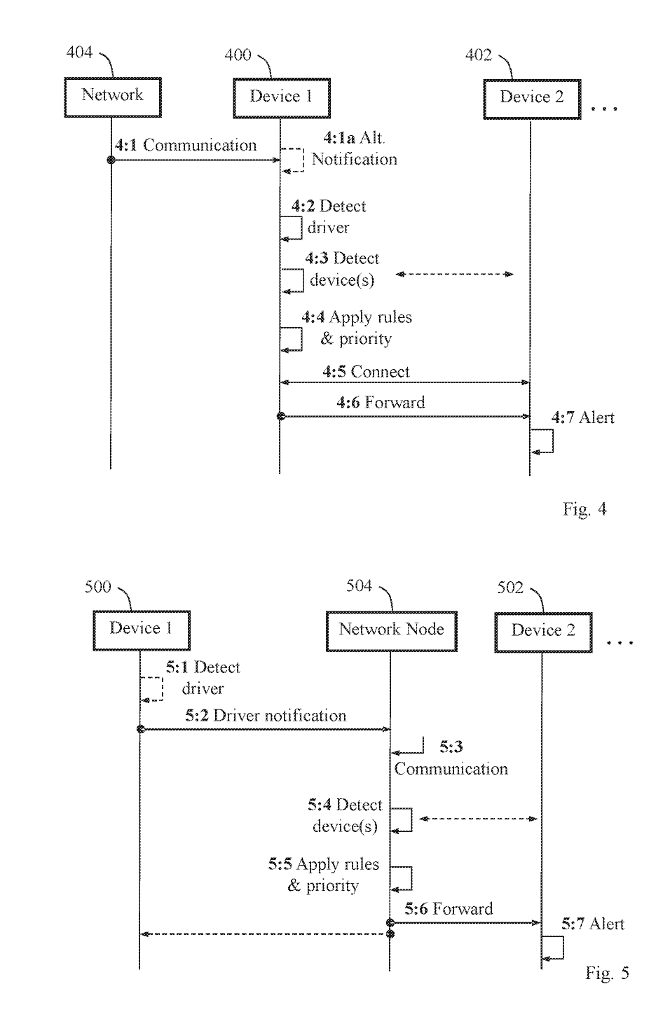

A more detailed example of how the control node and its functionality may be implemented in a network node will be described later below with reference to the signalling diagram of FIG. 5.

In another possible embodiment, the control node may instead be implemented in a vehicle node residing in the vehicle and capable of wireless communication with the first and second wireless devices, e.g. such as the vehicle node 106 in FIG. 1. In that case, another possible embodiment may be that the first wireless device and the second wireless device are connected to the vehicle node over local links for short-range communication.

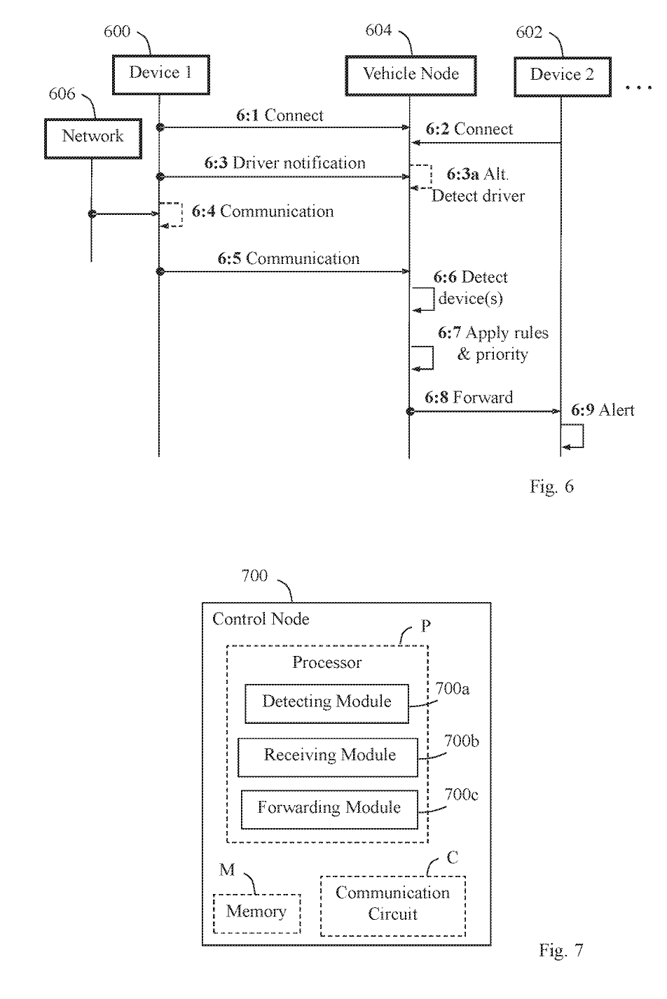

A more detailed example of how the control node and its functionality may be implemented in a vehicle node will be described later below with reference to the signalling diagram of FIG. 6.

The above-mentioned option of implementing the control node in the first wireless device will now be described with reference to the signaling diagram in FIG. 4, involving a first wireless device 400, a second wireless device 402 and a wireless network 404, such as a network node, serving the first and second devices 400, 402. A first action 4:1 illustrates that the first wireless device 400 receives an incoming communication from the network 404. Alternatively, the incoming communication may be an internal notification such as a reminder or the like, as indicated by an alternative action 4:1a. In either case, a further action 4:2 illustrates that the first device 400 detects that it is operated by a person that drives the vehicle. Some examples of how this detection may be done have been described above.

Another action 4:3 illustrates that the first device 400 also detects that one or more further wireless devices are present in the vehicle, which may be done as exemplified above. In this example, at least the second device 402 is detected in this action as present in the vehicle. Next, the first device 400 retrieves predefined forwarding rules pertaining to the first wireless device. Several examples of such forwarding rules have been described at length above in connection with action 204. The first device 400 may also retrieve priorities if more than one further device has been detected in the vehicle. The first device 400 applies the rules and priorities, if any, in an action 4:4.

In this example, the first device 400 finds that the second wireless device satisfies the forwarding rules and is qualified to take the incoming communication, e.g. after also executing the algorithm depicted in FIG. 3 or similar if more than one further device is present. Then the first and second devices 400, 402 establish a connection in action 4:5, and the first device 400 forwards the communication in action 4:6. Finally, the second device 402 emits an alert, e.g. sound and/or vibration, in action 4:7, to enable its user to act upon the communication.

The above-mentioned option of implementing the control node in a network node will now be described with reference to the signaling diagram in FIG. 5, involving a first wireless device 500, a second wireless device 502 and a network node 504. A first action 5:1 illustrates that the first device 500 is detected as being operated by the driver of the vehicle, which may be done by the device 500 itself or by a sensor in the vehicle, which has been described above. In either case, the network node 504 receives a driver notification in an action 5:2, which may come from the device 500 itself or from a sensor in the vehicle.

A further action 5:3 illustrates that the network node 504 receives an incoming communication directed or destined to the first device 500. In this implementation, the incoming communication is external by coming from another party, not shown, e.g. a call, message or some pushed content.

Another action 5:4 illustrates that the network node 504 detects that one or more further wireless devices are present in the vehicle, which may be done based on positioning information usually available in the network. In this example, at least the second device 502 is detected in this action as present in the vehicle. Next, the network node 504 retrieves predefined forwarding rules pertaining to the first wireless device 500. The network node 504 may also retrieve priorities if more than one further device has been detected in the vehicle. The network node 504 applies the rules and priorities, if any, in an action 5:5.

In this example, the network node 504 finds that the second wireless device satisfies the forwarding rules and is qualified to take the incoming communication, e.g. after also executing the algorithm depicted in FIG. 3 or similar if more than one further device is present. Then the network node 504 forwards the communication in action 5:6. As mentioned above, the communication may also be sent to the first device 500, as indicated by a dashed arrow, e.g. if it is a message or external notification that can be read later, but preferably without the first device 500 emitting any alerting sound or vibration so as to not distract the first user when driving. Finally, the second device 502 emits an alert, e.g. sound and/or vibration, in action 5:7, to enable its user to act upon the communication.

The above-mentioned option of implementing the control node in a vehicle node will now be described with reference to the signaling diagram in FIG. 6, involving a first wireless device 600, a second wireless device 602, the vehicle node 604 and a wireless network 606 serving the first and second devices 600, 602. A first action 6:1 illustrates that the first device 600 connects to the vehicle node 604 and another action 6:2 illustrates that the second device 602 likewise connects to the vehicle node 604, both connections being short-range connections such as Bluetooth or WiFi.

Then the vehicle node 604 receives a driver notification in an action 6:3 from the first device 600. Alternatively or additionally, the vehicle node 604 may itself detect that the user of device 600 is the driver by means of a sensor in the vehicle, as schematically indicated by a dashed action 6:3a. In either case, the first device 600 needs to know that its user is the driver in order to forward any incoming communication as follows.

A further action 6:4 illustrates that the first device 600 receives an incoming communication directed or destined to the first device 600. The incoming communication may be external as delivered by the network 606, e.g. a call, message or some pushed content, or internal as generated by the first device 600, dashed arrow, e.g. a reminder or the like. In this example, the vehicle node 604 at some point receives the incoming communication being forwarded from the first device 600, as shown by another action 6:5.

Another action 6:6 illustrates that the vehicle node 604 detects that one or more further wireless devices are present in the vehicle, which may be done when those devices locally connect to the vehicle node 604 as for example in action 6:2 above. In this example, at least the second device 602 is detected as present in the vehicle. Next, the vehicle node 604 retrieves predefined forwarding rules pertaining to the first wireless device 600, which may be retrieved from the first device 600 itself or from the network 606. The vehicle node 604 may also likewise retrieve priorities if more than one further device has been detected in the vehicle. The vehicle node 604 applies the rules and priorities, if any, in an action 6:7.

In this example as well, the vehicle node 604 finds that the second wireless device 602 satisfies the forwarding rules and is qualified to take the incoming communication, e.g. after also executing the algorithm depicted in FIG. 3 or similar if more than one further device is present. Then the vehicle node 604 forwards the communication in action 6:8. Finally, the second device 602 emits an alert, e.g. sound and/or vibration, in action 6:9, to enable its user to act upon the communication. It should be noted that the first device 600 may forward the communication to the vehicle node 604 as of action 6:5 not until after being notified that there is actually another device present in the vehicle that is qualified to take the communication, which would be after actions 6:6 and 6:7 have been executed and the vehicle node 604 has informed the first device 600 accordingly.

The block diagram in FIG. 7 illustrates a detailed but non-limiting example of how a control node 700 may be structured to bring about the above-described solution and embodiments thereof. In this figure, the control node 700 may thus be configured to operate according to any of the examples and embodiments of employing the solution as described above, where appropriate, and as follows. The control node 700 is shown to comprise a processor “P”, a memory “M” and a communication circuit “C” with suitable equipment for transmitting and receiving signals with data and messages in the manner described herein.

The communication circuit C in the control node 700 thus comprises equipment configured for communication with a caller and various subscribers, not shown, using one or more suitable communication protocols depending on implementation. As in the examples discussed above, the control node 700 described herein may be implemented in a wireless device or in a network node or in a vehicle node. The control node 700 comprises means configured or arranged to perform at least some of the actions of the flow charts and signaling diagrams illustrated in FIGS. 2-6, in the manner described above. These actions may be performed by means of functional modules in the processor P in the control node 700 as follows.

The control node 700 is arranged to handle incoming communication directed to a first wireless device when a user of the first wireless device is driving a vehicle. The control node 700 thus comprises a processor P and a memory M, said memory comprising instructions executable by said processor, whereby the control node 700 is operable as follows.

The control node 700 comprises means configured to detect a second wireless device that is present in the vehicle. This detecting activity may be performed by a detecting module 700a in the control node 700, e.g. in the manner described for action 200 above. The control node 700 also comprises means configured to receive an incoming communication directed to the first wireless device. This receiving activity may be performed by a receiving module 700b in the control node 700, e.g. in the manner described for action 202 above.

The control node 700 further comprises means configured to forward the incoming communication to the second wireless device, thereby enabling a user of the second wireless device to act upon the incoming communication. This forwarding activity may be performed by a forwarding module 700c in the control node 700, e.g. in the manner described for action 204 above.

It should be noted that FIG. 7 illustrates some possible functional modules in the control node 700 and the skilled person is able to implement these functional modules in practice using suitable software and hardware. Thus, the solution is generally not limited to the shown structure of the control node 700, and the functional modules 700a-c may be configured to operate according to any of the features described in this disclosure, where appropriate.

The embodiments and features described herein may thus be implemented in a computer program comprising instructions which, when executed on at least one processor, cause the at least one processor to carry out the above actions e.g. as described for any of FIGS. 2-6. Further, the above-described embodiments may be implemented in a carrier containing the above computer program, wherein the carrier is one of an electronic signal, optical signal, radio signal, or computer readable storage medium. The computer readable storage medium may be a compact disc or other carrier suitable for holding the computer program. Some examples of how the computer program and the carrier can be realized in practice are outlined below, and with further reference to FIG. 7.

The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

The memory M may comprise the above-mentioned computer readable storage medium or carrier on which the computer program is stored e.g. in the form of computer program modules or the like. For example, the memory M may be a flash memory, a Random-Access Memory (RAM), a Read-Only Memory (ROM) or an Electrically Erasable Programmable ROM (EEPROM). The program modules could in alternative embodiments be distributed on different computer program products in the form of memories within the control node 700.

It was mentioned above that the forwarding may be allowed if the second wireless device has previously been assigned to receive the incoming communication in accordance with an agreement or the like between the first and second devices. This agreement may be defined by executing a pairing procedure for the first and second devices and two examples of pairing procedure will now be briefly described.

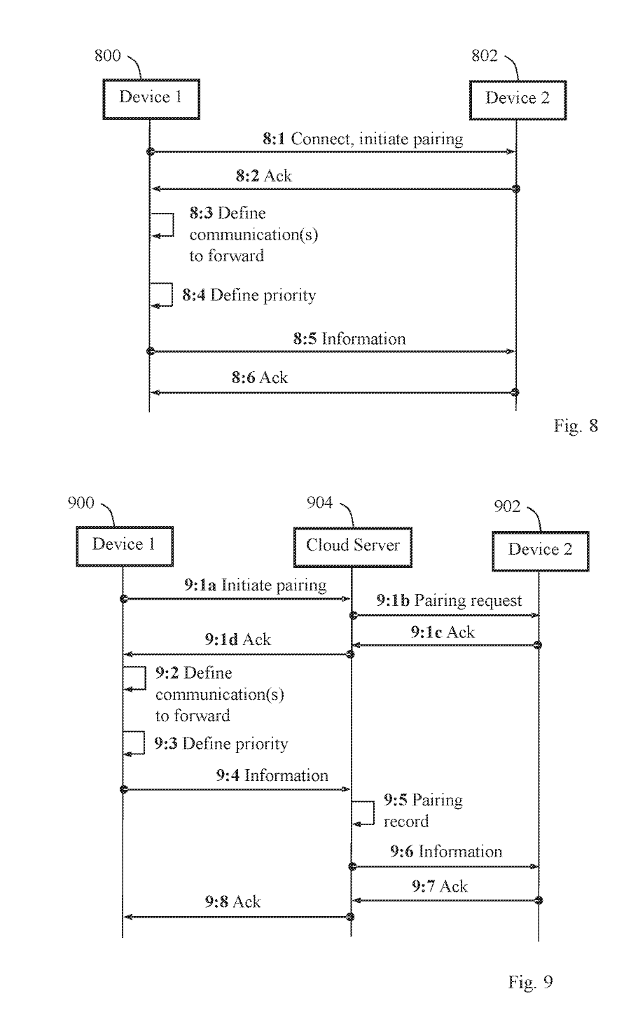

Firstly, the signaling diagram in FIG. 8 illustrates a pairing procedure involving only the first and second devices 800, 802. In a first shown action 8:1 the first device 800 connects to the second device 802, e.g. over a public wireless network or using a short-range communication link such as Bluetooth, in order to initiate the pairing procedure. A next action 8:2 illustrates that the second device 802 acknowledges the connection and pairing invitation. A next action 8:3 illustrates that it is defined in the first device 800 what type(s) of communications should be allowed to be forwarded to the second device 902. Other parameters related to the forwarding may also be defined in this action. Another action 8:4 illustrates that a priority of the second device 802 may also be defined in the first device 800 in case further devices are also allowed to receive forwarded communications directed to the first device 800.

The first device 800 then sends to the second device 802 in an action 8:5, a record or the like containing information about the definitions made in the forgoing actions 8:3, 8:4, which can be seen as a specification of the pairing agreement which could be documented in the form of a pairing record or the like. The second device 802 then acknowledges the pairing agreement in a final shown action 8:6.

Secondly, the signaling diagram in FIG. 9 illustrates another example of a pairing procedure involving the first and second devices 900, 902 and an intermediate server 904 which is implemented in “the cloud”, i.e. somewhere in the Internet, here denoted “cloud server”. Initially, a set of actions 9:1a-d illustrates how the pairing procedure is activated and established. In a first shown action 9:1a, the first device 900 connects to the cloud server 904 in order to initiate the pairing procedure with the second device 902. The cloud server 904 comprises suitable software that is thereby activated for executing the pairing procedure as follows. In another action 9:1b, the cloud server 904 forwards a pairing request to the second device 902 which then responds with an acknowledgement in action 9:1c, which may be triggered by manual input by the second user. The acknowledgement is forwarded to the second device 902 in action 9:1d.

A next action 9:2 illustrates that it is defined in the first device 900 what type(s) of communications should be allowed to be forwarded to the second device 902, as similar to action 8:3 above. Other parameters related to the forwarding may also be defined in this action. Another action 9:3 illustrates that a priority of the second device 902 may also be defined in the first device 900 in case further devices are also allowed to receive forwarded communications directed to the first device 900, as similar to action 8:4 above.

The first device 900 then sends to the cloud server 904, in an action 9:4, a record or the like containing information about the definitions made in the forgoing actions 9:2, 9:2, as a specification of the pairing agreement. The cloud server 904 then stores a corresponding pairing record in an action 9:5 and sends information about the pairing to the second device 902 in another action 9:6. The second device 802 then accepts the pairing agreement by sending an acknowledgement to the cloud server 904 in another action 9:7, and the cloud server 904 also acknowledges to the first device 900 that the pairing agreement is completed, in a final shown action 9:8.

The above-described examples of FIGS. 8 and 9 may be executed at least partly automatically or in response to input provided by the respective users of the devices.

While the solution has been described with reference to specific exemplifying embodiments, the description is generally only intended to illustrate the inventive concept and should not be taken as limiting the scope of the solution. For example, the terms “control node”, “communication”, “wireless device”, “network node”, “vehicle node” and “driver notification” have been used throughout this disclosure, although any other corresponding entities, functions, and/or parameters could also be used having the features and characteristics described here. The solution is defined by the appended claims.

1. A method performed by a control node for handling incoming communication directed to a first wireless device when a user of the first wireless device is driving a vehicle, the method comprising:
detecting a second wireless device that is present in the vehicle,
receiving an incoming communication directed to the first wireless device, and
forwarding the incoming communication to the second wireless device, thereby enabling a user of the second wireless device to act upon the incoming communication.

2. A method according to claim 1, wherein the incoming communication comprises any of: a phone call, pushed content, a message and an external or internal notification.

3. A method according to claim 1, wherein the incoming communication is forwarded to the second wireless device based on predefined forwarding rules pertaining to the first wireless device and related to at least one of:
the second wireless device has been assigned to receive the incoming communication,
at least one previous incoming communication has been forwarded to the second wireless device,
the first and second wireless devices have communicated with one another at least a certain number of times,
a contact list in the second wireless device includes the first wireless device,
a contact list in the first wireless device includes the second wireless device,
the type of communication received,
origin of the incoming communication, and
the time of day, week or season.

4. A method according to claim 1, wherein at least a third wireless device is also present in the vehicle and the second wireless device is selected to receive the incoming communication based on a forwarding priority of the second wireless device being higher than a forwarding priority of the third wireless device.

5. A method according to claim 1, wherein the incoming communication is forwarded to the second wireless device if the user of the first wireless device has been detected as driving the vehicle based on a driver notification from the first wireless device or from a sensor in the vehicle.

6. A method according to claim 5, wherein the control node is implemented in the first wireless device.

7. A method according to claim 6, wherein the first wireless device forwards the incoming communication to the second wireless device over a Bluetooth link, a WiFi link or a public wireless network.

8. A method according to claim 1, wherein the control node is implemented in a network node of a wireless network.

9. A method according to claim 8, wherein the network node forwards the incoming communication to the second wireless device based on retrieving at least one of:
pairing information about the first and second wireless devices,
relative proximity of the first and second wireless devices, and
predefined forwarding rules pertaining to the first wireless device.

10. A method according to claim 1, wherein the control node is implemented in a vehicle node residing in the vehicle and capable of wireless communication with the first and second wireless devices.

11. A method according to claim 10, wherein the first wireless device and the second wireless device are connected to the vehicle node over local communication links.

12. A control node arranged to handle incoming communication directed to a first wireless device when a user of the first wireless device is driving a vehicle, the control node configured to:
detect a second wireless device that is present in the vehicle,
receive an incoming communication directed to the first wireless device, and
forward the incoming communication to the second wireless device, thereby enabling a user of the second wireless device to act upon the incoming communication.

13. A control node according to claim 12, wherein the incoming communication comprises any of: a phone call, pushed content, a message and an external or internal notification.

14. A control node according to claim 12, wherein the control node is configured to forward the incoming communication to the second wireless device based on predefined forwarding rules pertaining to the first wireless device and related to at least one of:
the second wireless device has been assigned to receive the incoming communication,
at least one previous incoming communication has been forwarded to the second wireless device,
the first and second wireless devices have communicated with one another at least a certain number of times,
a contact list in the second wireless device includes the first wireless device,
a contact list in the first wireless device includes the second wireless device,
the type of communication received,
origin of the incoming communication, and
the time of day, week or season.

15. A control node according to claim 12, wherein at least a third wireless device is also present in the vehicle and the control node is configured to select the second wireless device to receive the incoming communication based on a forwarding priority of the second wireless device being higher than a forwarding priority of the third wireless device.

16. A control node according to claim 12, wherein the control node is configured to forward the incoming communication to the second wireless device if the user of the first wireless device has been detected as driving the vehicle based on a driver notification from the first wireless device or from a sensor in the vehicle.

17. A control node according to claim 12, wherein the control node is implemented in the first wireless device.

18. A control node according to claim 17, wherein the control node is configured to forward the incoming communication to the second wireless device over a Bluetooth link, a WiFi link or a public wireless network.

19. A control node according to claim 12, wherein the control node is implemented in a network node of a wireless network.

20. A control node according to claim 19, wherein the control node is configured to forward the incoming communication to the second wireless device based on retrieving at least one of:
pairing information about the first and second wireless devices,
relative proximity of the first and second wireless devices, and
predefined forwarding rules pertaining to the first wireless device.

21. A control node according to claim 12, wherein the control node is implemented in a vehicle node residing in the vehicle and capable of wireless communication with the first and second wireless devices.

22. A control node according to claim 21, wherein the first wireless device and the second wireless device are connected to the vehicle node over local communication links.

23. (canceled)

24. (canceled)
